(19) United States
(12) Patent Application Publication
(10) Pub. No.: US 2011/0169283 A1
(43) Pub. Date: Jul. 14, 2011

(54) Impact Absorbing Device and Front End Comprising Such A Device

(76) Inventors: Laurent Salin, Paris (FR); Sebastien Guinehut, Issy-Les-Moulineaux (FR); Jacques Sigonneau, Theuvy-Acheres (FR)

(21) Appl. No.: 12/993,439

(22) PCT Filed: May 19, 2009
(86) PCT No.: PCT/EP09/56047

§ 371 Date: Mar. 21, 2011

(30) Foreign Application Priority Data
May 22, 2008 (FR) FR 0802776

(51) Int. Cl. B60R 19/34

(52) U.S. Cl. 293/133

(57) ABSTRACT

The invention relates to an impact absorbing device (10) comprising as a minimum a bumper beam (12) and mounting plates (14-1; 14-2) for mounting the bumper beam (12) to the chassis of a motor vehicle. The bumper beam (12) comprises a central part (16) and connecting ends (18-1; 18-2). The central part (16) is offset with respect to the connecting ends (18-1; 18-2), and the connecting ends (18-1; 18-2) of the bumper beam (12) are fastened to the mounting plates (14-1; 14-2) by added connecting means. The device (10) also comprises a central impact absorber (22) and repairable impact absorbers (24-1; 24-2) and said repairable impact absorbers (24-1; 24-2) are separate from the connecting ends (18-1; 18-2) of the bumper beam (12). The invention also relates to a front end equipped with such an impact absorbing device with particular application to motor vehicles.

The invention relates to an impact absorbing device, especially as used in the motor vehicle industry, and a front end equipped with such a device.

It relates more particularly to an impact absorbing device comprising as a minimum a so-called bumper beam and mounting plates for mounting the bumper beam to the chassis of a motor vehicle. The bumper beam comprises a central part and so-called connecting ends, the central part being offset with respect to the connecting ends, and the connecting ends of the bumper beam being fastened to the mounting plates by added connecting means.

A bumper beam has several functions. It participates in the structure of the vehicle and protects passengers and the equipment of the motor vehicle in the event of an impact with an external obstacle. Moreover, the bumper beam also has the function of reducing the danger posed by the vehicle, especially towards pedestrians, by absorbing some of the energy of the impact in such a way as to minimize the severity of the injuries inflicted on pedestrians.

Document DE 10 2005 017 956 discloses an impact absorbing device as described above. The document provides a bumper beam into which an impact absorber is fitted in such a way as to form repairable impact absorbers by the combination of said beam with said absorber.

“Repairable impact absorber” here means an absorber that absorbs so-called corner, parking or insurance impacts, i.e. an absorber which, for an impact of this type and having around 10 000 joules of energy to be absorbed, comprising about 7000 joules to be absorbed by an “upper pathway” assembly incorporating the beam, the repairable impact absorber, and a supplementary impact absorber, such as an impact absorber located at the front of the repairable impact absorber and beam, termed the pedestrian impact absorber, can absorb around 2700 joules while the rest of the energy will be absorbed by the beam and by the other supplementary impact absorber.

A device as described in the document cited above is not satisfactory because in such a case several parts have to be assembled together to make up the repairable impact absorbing device and the different parts have to be precisely the right size in order to fit together correctly.

In addition, in the event of an impact with an external obstacle, the whole impact absorbing device has to be changed, creating extra costs and potentially increases in insurance premiums, as the insurance premium may be calculated from the cost of these repairs.

Moreover, regulations—especially European regulations such as European Directive 2003/102/EC concerning impact absorption and more especially the absorption of so-called repairable and high-speed impacts—are very strict.

In order to comply with these regulations, the design of impact absorbing devices has to be modified in such a way as to incorporate new elements such as energy absorbers which increase the overall cost of impact absorbing devices. This leads to difficulties in terms of both the raw material costs and the costs of assembly.

The object of the invention is to improve the situation.

To this end, the invention provides an impact absorbing device as described above that also comprises a so-called central impact absorber and so-called repairable impact absorbers, and in which the repairable impact absorbers are separate from said connecting ends of the bumper beam.

A device according to the invention thus increases the modularity of the impact absorbing device to suit the type of motor vehicle and to suit the various standards to be complied with.

The invention also relates to a front end equipped with such an impact absorbing device.

As readers will be aware, the front end is a structural element comprising a frame capable of supporting vehicle equipment such as for example headlamps, turn signals, horn, heat exchanger and/or complete cooling module.

A front end thus equipped constitutes a unitary component, also known as the front end module, prepared and delivered by the equipment manufacturer, ready to be fitted to the vehicle by the vehicle maker. This unitary module is fitted by mounting the frame to the vehicle's lateral structural elements, such as side members, fenders, or body, then attaching a bumper or front apron to the module.

Other advantages and features of the invention will become clearer in the course of reading of the illustrative, non-restrictive description of examples drawn from the figures of the appended drawings, in which:

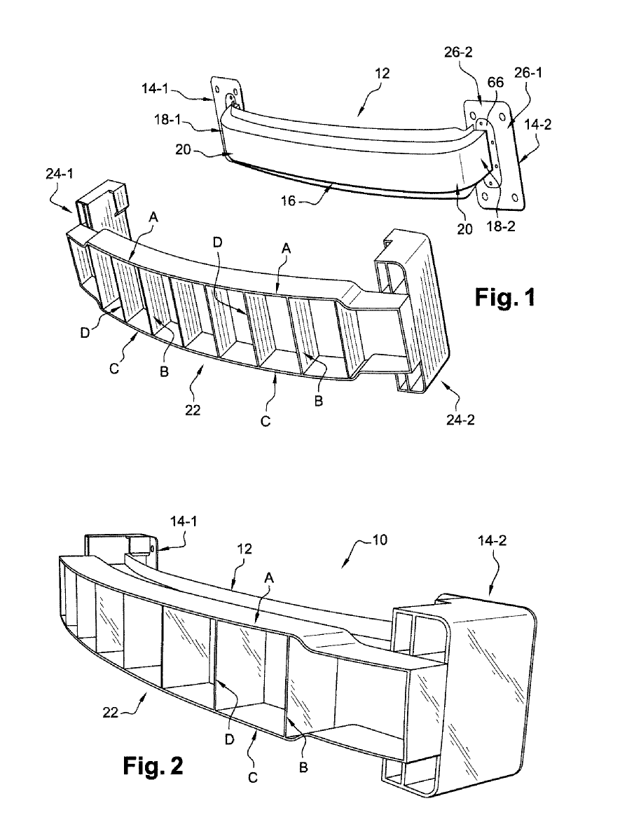

FIG. 1 is an exploded view an impact absorbing device according to the present invention;

FIG. 2 is an assembly view of the impact absorbing device seen in FIG. 1;

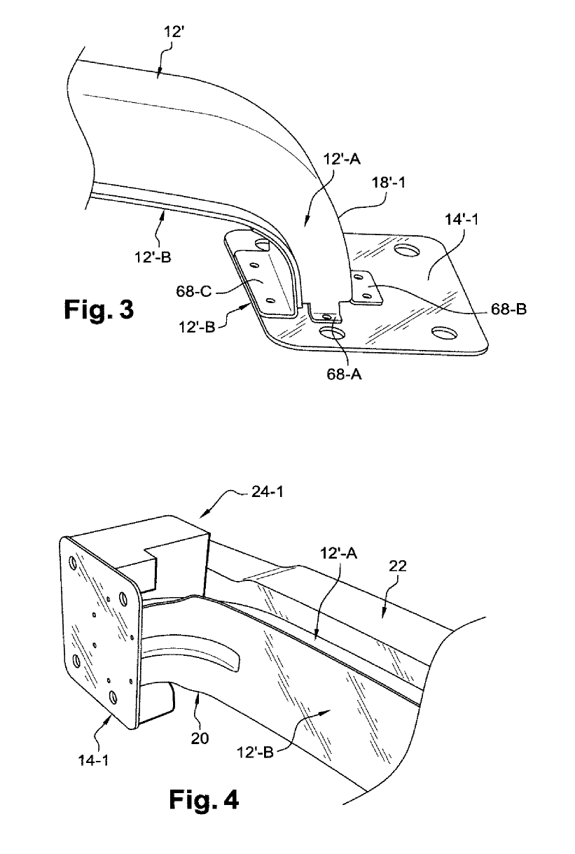

FIG. 3 shows a detail of the bumper beam/mounting plate mounting zone of a bumper beam in a second embodiment of the present invention;

FIG. 4 is a rear view of an impact absorbing device comprising the bumper beam in accordance with the embodiment seen in FIG. 3;

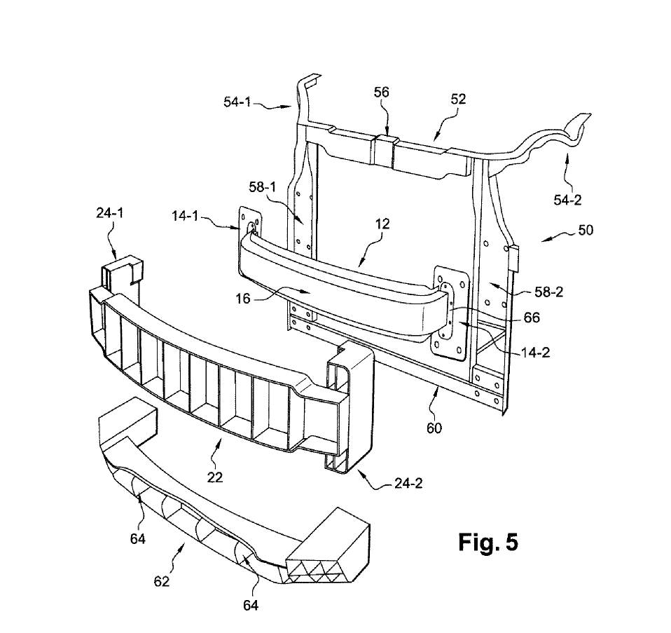

FIG. 5 is an exploded view of a front end comprising an impact absorbing device according to the present invention.

As illustrated in FIGS. 1 and 2, the invention relates to an impact absorbing device 10 comprising at least one so-called bumper beam 12, and mounting plates 14-1 and 14-2 for mounting the bumper beam 12 to the chassis of a motor vehicle.

The bumper beam 12 comprises a central part 16, and so-called connecting ends 18-1 and 18-2, and its general cross section is for example U-shaped. In this embodiment the U of the profile of the bumper beam is pointing towards the mounting plates. In other words the U of the beam opens towards the rear of the vehicle, once the impact absorbing device is mounted on the motor vehicle.

The bumper beam 12 may be made by stamping or hydroforming a hollow aluminum or perhaps steel extrusional section.

The central part 16 is offset with respect to the connecting ends 18-1, 18-2. The offset of the central part 16 allows the latter to form a central energy-absorbing part. The connecting ends 18-1 and 18-2 are joined to the mounting plates 14-1 and 14-2 in a direction approximately tangential to the direction orthogonal to the plates 14-1 and 14-2. In other words, in such a situation the connecting ends 18-1 and 18-2 extend rearwards of the central part 16, once the impact absorbing device is mounted on the motor vehicle.

In other words, the connecting ends 18-1 and 18-2 are approximately at a right angle to the axis of the general extension of the central part 16 of the beam 12 and the connecting ends 18-1 and 18-2 are connected to the central part 16 by a curved connecting part 20 which has a point of inflection.

The connecting ends 18-1 and 18-2 of the bumper beam 12 are fastened to the mounting plates 14-1 and 14-2 by added connecting means. In other words, in the embodiment shown in FIG. 1, the bumper beam 12 and the mounting plates 14-1 and 14-2 are two separate parts attached together by mounting means. These added connecting means may for example be screws, weld spots, and/or a weld lead.

In the embodiment shown here, the central part 16 and the mounting plates 14-1 and 14-2 are approximately parallel, so that the central part 16 is also offset with respect to the mounting plates 14-1 and 14-2.

In this embodiment, the connecting ends 18-1 and 18-2 of the bumper beam 12 comprise a collar 66 extending all the way around the perimeter of said connecting ends 18-1 and 18-2 and in a plane approximately perpendicular to the latter. In other words, the collar lies in a plane parallel to the axes of general extension of the central part 16 and the mounting plates 14-1 and 14-2.

The impact absorbing device 10 according to the invention is mounted to a motor vehicle chassis in such a way that the direction of the offset of the central part 16 effectively coincides with the X axis of the vehicle, in other words is forwards of the vehicle. This means that the central part 16 can form a central absorbing part that is offset forwards of the motor vehicle.

The mounting plates 14-1 and 14-2 comprise a first zone 26-1 and a second zone 26-2. The zones 26-1 and 26-2 are separate zones.

What is meant by “separate” is that, if one considers any segment defined between two points of said second zone, this segment does not include said first zone. In other words, said repairable impact absorbers are not embedded in said connecting ends but adjacent to them.

In addition, the mounting plates 14-1 and 14-2 each contain holes, of which there are four in the present case, for mounting the bumper beam 12 to a structural element of the motor vehicle. In the embodiment illustrated in FIG. 5, the structural element is a front end frame 50.

In other words, once the impact absorbing device has been assembled, the whole of the contact area of the repairable impact absorbers is projected onto the mounting plates.

According to the invention, the device 10 also comprises a so-called central impact absorber 22 and so-called repairable impact absorbers 24-1 and 24-2.

The central impact absorber 22 is also known as a “pedestrian” absorber. As shown in FIG. 2, the latter is able to be positioned in front of the central part 16 of the bumper beam 12 and in such a way as to contribute, in combination with the beam, in particular, to the absorption of so-called pedestrian and parking impacts.

In other words, in this example, the central impact absorber 22 adds energy absorbing material to the front of the bumper beam 12. It is thus possible to size the central absorber precisely in order to comply with the conditions of different regulations and/or specifications of manufacturers yet still have a single reference bumper beam.

The central absorber 22 here comprises a cellular portion. The cellular portion in this embodiment is made in the form of motifs which are repeated all the way along the length of the absorber.

In this embodiment the motif is in the form of a box or caisson comprising an open face. The walls of the box are here formed by reinforcing ribs A, B, C and D. In other words, the cellular portion is defined at least partly by reinforcing ribs.

The repairable impact absorbers 24-1 and 24-2 each comprise a so-called contact surface placed face to face with the first zone 26-1 of the mounting plates 14-1 and 14-2, once the impact absorbing device is assembled. “Contact surface” here means that face of the repairable impact absorbers 24-1 and 24-2 which faces the mounting plates 14-1 and 14-2.

Here, the repairable impact absorbers 24-1 and 24-2 are mounted to the mounting plates 14-1 and 14-2 rather than to the bumper beam 12.

In one embodiment, the repairable impact absorbers 24-1 and 24-2 are added to the first zone 26-1 of the mounting plates 14-1 and 14-2 and extend in the same direction as the offset of the central part 16 of the bumper beam 12, occupying at least the space defined between the connecting ends of the bumper beam and the zone distal from the bumper beam of the mounting plates (in other words the first zone of the mounting plates).

In other words, here, the repairable impact absorbers are situated not in but near the bumper beam and their volume is separate from that of the bumper beam.

In other words, again, and as shown in FIG. 2, the repairable impact absorbers 24-1 and 24-2 are placed “in front of” the mounting plates 14-1 and 14-2, which makes them more accessible and they extend towards the rear once the device according to the invention is mounted on the motor vehicle.

It is thus possible, in an impact, for the repairable impact absorbers 24-1 and 24-2 and the central part 16 of the bumper beam 12 to be stressed approximately simultaneously.

In other embodiments, it would be possible to have a depth of offset of the central part of the bumper beam greater (or alternatively smaller) than that of the repairable impact absorbers 24-1 and 24-2, so as to stress the central part 16 first (or alternatively the repairable impact absorbers 24-1 and 24-2) in an impact.

In one embodiment the repairable impact absorbers 24-1 and 24-2 comprise at least one housing suitable for containing an impact absorbing material.

In this case the repairable impact absorbers will themselves also comprise a cellular structure and this cellular structure allows a plurality of housings to be defined, at least one of which may accommodate said impact absorbing material, e.g. expanded aluminum.

In the embodiment illustrated in FIGS. 1 and 2, the central impact absorber 22 and the repairable impact absorbers 24-1 and 24-2 are made in one piece.

As already outlined above, the front end 50 is a frame suitable for supporting motor vehicle equipment such as headlamps and heat exchangers (not shown).

FIG. 3 shows a detail of the bumper beam 12′/mounting plate 18′-1 mounting zone of a device in a second embodiment.

In this embodiment the bumper beam 12′ is made in two parts, namely a first part 12′-A with a U-shaped general profile, and a second part 12′-B whose function is to strengthen the profile of the first part 12′-A. Hereinafter the second part 12′-B will be called the reinforcing plate 12-B.

Here, the reinforcing plate 12′-B closes the U profile of the first part 12′-A. In other words the reinforcing plate forms a cover for the first part 12′-A.

The first part 12′-A and the reinforcing plate 12′-B are connected by fixing means such as rivets for example.

The first part 12′-A and the reinforcing plate 12′-B both comprise a central part (not shown) and connecting ends, only one of which (18′-1) is shown in FIG. 2. Once again, the central parts of the first part 12-A and of the reinforcing plate 12′-B are offset with respect to their respective connecting ends.

The central parts of the first part 12′-A and of the reinforcing plate 12′-B, and the connecting ends of the first part 12′-A and of the reinforcing plate 12′-B, are respectively placed face to face with each other to form the bumper beam 12′.

In addition, the first part 12′-A and the reinforcing plate 12′-B are each connected at their respective connecting ends to a mounting plate. This connection is in this case formed by tabs.

In the example shown in FIG. 3, the first part 12′-A comprises three tabs, of which only two (68-A and 68-B) can be seen. The reinforcing plate 12′-B comprises a tab 68-C.

Each of the tabs extends in a plane parallel to the axes of general extension of the central part first part and of the reinforcing plate and mounting plates.

The connecting ends are connected to the mounting plate in the latter's second zone.

FIG. 4 is a rear view of an absorbing device comprising a bumper beam 12′. Here, the reinforcing plate 12′-B has a rib at the curved connecting part 20 and at the connecting end where it meets the mounting plate. The function of this recess is to locally stiffen the beam.

In the embodiment shown in FIG. 5, the frame of the front end 50 is in this case made entirely of steel.

The front end 50 comprises a crossmember 52 called the upper crossmember, which is basically horizontal. The upper crossmember 52 has two so-called lateral ends 54-1 and 54-2 that are able to at least partly support the headlamps and a central part 56 able to accommodate a lock bracket.

The front end 50 also has two uprights 58-1 and 58-2. In this case the two uprights 58-1 and 58-2 are basically vertical and positioned one on the right side and the other on the left side of the vehicle. These two uprights are also known as “jambs” or “quarters”.

The uprights 58-1 and 58-2 are connected by their so-called upper ends to the upper crossmember 52. In other words the uprights 58-1 and 58-2 are joined to each other by the upper crossmember 52 running between their upper ends.

The front end comprises, in the present case, a lower crossmember 60. The lower crossmember 32 is joined to the uprights 58-1 and 58-2 via their so-called lower ends. The lower crossmember 60 is basically horizontal and is parallel to the upper crossmember 52.

The bumper beam 12 and thus the impact absorbing device of the invention is mounted to the uprights 58-1 and 58-2 through the mounting plates 14-1 and 14-2.

In this embodiment the bumper beam 12 is approximately horizontal and parallel to the upper crossmember 52 and to the lower crossmember 60.

In the embodiment shown in FIG. 5, a pedestrian beam is mounted to the front end 50 at the lower crossmember 60.

Here, the pedestrian beam 62 is made in the form of a structure, e.g. plastic, that is at least partly cellular and impact absorbing. The pedestrian beam 62 has reinforcing ribs 64 to stiffen the structure of the pedestrian beam 62. A metal reinforcement overmolded with the impact absorbing plastic structure, or fastened to it, can be provided.

The invention is not limited to the embodiments described hereinabove purely as examples, but rather encompasses all variants that may be devised by a person skilled in the art within the scope of the following claims. The variants described above may be taken separately or in combination with each other.

1. An impact absorbing device (10) comprising bumper beam (12) and mounting plates (14-1; 14-2) for mounting said bumper beam (12) to the chassis of a motor vehicle, said bumper beam (12) comprising a central part (16) and connecting ends (18-1; 18-2), said central part (16) being offset with respect to said connecting ends (18-1; 18-2), and said connecting ends (18-1; 18-2) of said bumper beam (12) being fastened to said mounting plates (14-1; 14-2) by added connecting means, said device (10) comprising a central impact absorber (22) and repairable impact absorbers (24-1; 24-2), with said repairable impact absorbers (24-1; 24-2) being separate from said connecting ends (18-1; 18-2) of said bumper beam (12).

2. The impact absorbing device as claimed in claim 1, in which said mounting plates (14-1; 14-2) comprise a first zone (26-1) and a second separate zone (26-2) and in which said repairable impact absorbers (24-1; 24-2) comprise a contact surface placed face to face with said first zone (24-1) and in which said connecting ends (18-1; 18-2) of said bumper beam (12) are located face to face with said second zone (26-2).

3. The impact absorbing device as claimed in claim 1, in which said connecting ends (18-1; 18-2) are joined to said mounting plates (14-1; 14-2) in a direction approximately tangential to the direction orthogonal to said mounting plates (14-1; 14-2).

4. The impact absorbing device as claimed in claim 1, in which said central impact absorber (22) is able to be positioned in front of said central part (16) of said bumper beam (12).

5. The impact absorbing device as claimed in claim 1, in which said central impact absorber (22) and said repairable impact absorbers (24-1; 24-1) are made in one piece.

6. The impact absorbing device as claimed in claim 1, in which said repairable impact absorbers (24-1; 24-2) comprise at least one housing suitable for containing an impact absorbing material.

7. The impact absorbing device as claimed in claim 1, in which said central impact absorber (22) comprises a cellular portion, said cellular portion being defined at least partly by reinforcing ribs (A; B; C; D).

8. A front end (50) for a motor vehicle comprising at least one upper crossmember (52), uprights (58-1; 58-2), and an impact absorbing device as claimed in claim 1, said device being mounted to said uprights (58-1; 58-2) of said front end (50).

9. The front end as claimed in claim 8, additionally comprising a pedestrian beam (62).

10. The front end as claimed in claim 9, in which said pedestrian beam (62) is made in a cellular impact absorbing structure.

11. The impact absorbing device as claimed in claim 2, in which said connecting ends (18-1; 18-2) are joined to said mounting plates (14-1; 14-2) in a direction approximately tangential to the direction orthogonal to said mounting plates (14-1; 14-2).

12. The impact absorbing device as claimed in claim 2, in which said central impact absorber (22) comprises a cellular portion, said cellular portion being defined at least partly by reinforcing ribs (A; B; C; D).
